(19) United States
(12) Patent Application Publication
(10) Pub. No.: US 2017/0341262 A1
(43) Pub. Date: Nov. 30, 2017

(54) WOOD-THAWING INSTALLATION

(71) Applicant: SPRINGER MASCHINENFABRIK GMBH, 9360 Friesach (AT)

(72) Inventors: GERHARD FENKART, Regensdorf (CH); ALFRED WIDU, St. Veit/Glan (AT)

(73) Assignee: SPRINGER MASCHINENFABRIK GMBH, 9360 Friesach (AT)

(21) Appl. No.: 15/524,900

(22) PCT Filed: Nov. 6, 2015
(86) PCT No.: PCT/AT2015/000140

§ 371 Date: May 5, 2017

(30) Foreign Application Priority Data
Nov. 7, 2014 (AT) A 815/2014

(51) Int. Cl. B27K 5/00; B05B 13/02; B05B 15/04

(52) U.S. Cl. CPC B27K 5/001; B05B 15/0406; B05B 13/0221; B05B 13/0278; B65G 2201/0282

(57) ABSTRACT

A wood-thawing installation for thawing frozen pieces of raw timber includes a thawing channel. The thawing channel has an entrance and an exit for the pieces of raw timber for the raw wood pieces to enter and exit the thawing channel. A plurality of nozzles are located on the thawing channel to introduce a thawing liquid into the thawing channel. A first section of the thawing channel and a second section of the thawing channel are located between the entrance and the exit. The exit is closer to the second section than to the first section. At least one of the nozzles is located in the first section and connected via a pumping line to a suction opening located in the second section. Further disclosed is a method for thawing frozen raw wood pieces.

The invention relates to a wood-thawing installation according to the preamble of Patent Claim 1.

Raw wood, for example, tree trunks, are often stored outside, wherein they can also freeze at low temperatures. Before further processing, for example, into oriented strand boards, the frozen raw wood is thawed. Conveying the raw wood through a basin having hot water in order to thaw it is known for this purpose.

This has the disadvantage that this process consumes a large amounₜ of energy, wherein a large amount of heat energy is also lost unused.

The object of the invention is therefore to specify a wood-thawing installation of the type mentioned at the outset, using which the mentioned disadvantages can be avoided, and using which the method for thawing can be performed more energy efficiently.

This is achieved according to the invention by the features of Patent Claim 1.

The advantage thus results that the thawing method of the raw wood can be performed particularly energy efficiently, wherein in particular a core of the raw wood can also be thawed particularly reliably. Due to the construction of the thawing channel in sections, wherein a pump line between the sections conveys the thawing liquid opposite to a conveyance direction of the raw wood pieces, similarly as in a countercurrent heat exchanger, particularly good heat transfer from the thawing liquid to the raw wood pieces can be achieved, wherein a local temperature difference between the thawing liquid and the raw wood piece can be kept small. Furthermore, the raw wood piece can thus be in contact at the exit of the thawing channel with an essentially hardly cooled and therefore particularly hot thawing liquid, whereby the core of the raw wood piece can also be thawed particularly reliably. At the entrance of the thawing channel, the thawing liquid is already strongly cooled, whereby hardly any heat energy is lost due to a removal of the thawing liquid at this point.

The invention furthermore relates to a method for thawing frozen raw wood pieces according to Patent Claim 10.

The object of the invention is therefore furthermore to specify a method of the type mentioned at the outset, using which the mentioned disadvantages can be avoided, and using which the method for thawing can be performed more energy efficiently.

This is achieved according to the invention by the features of Patent Claim 10.

The advantages of the method correspond to the advantages of the wood-thawing installation.

The dependent claims relate to further advantageous embodiments of the invention.

Reference is hereby expressly made to the wording of the patent claims, whereby the claims are incorporated at this point into the description by reference and are considered to be reproduced verbatim.

The invention will be described in greater detail hereafter with reference to the appended drawings, which merely illustrate a preferred embodiment by way of example. In the figures:

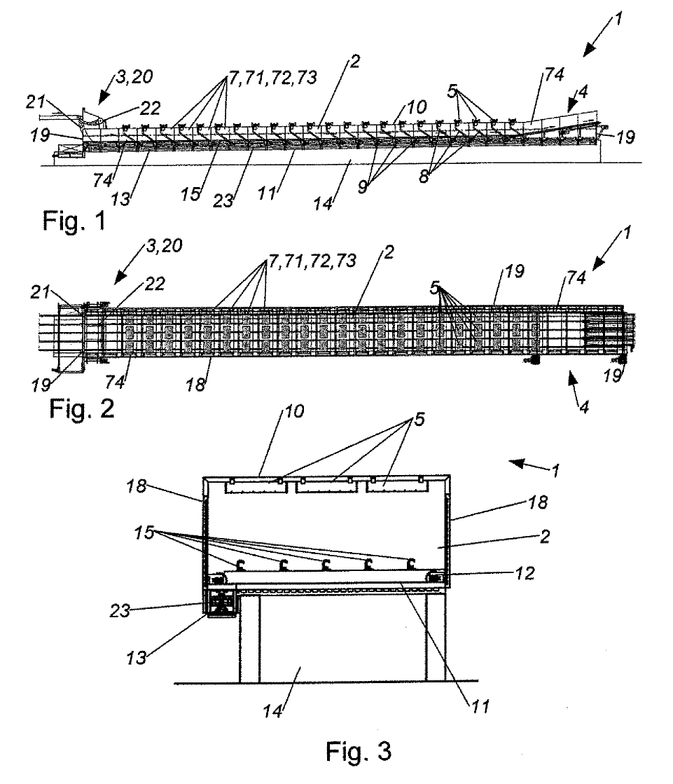

FIG. 1 shows a preferred embodiment of the wood-thawing installation as a section in a side view;

FIG. 2 shows a preferred embodiment of the wood-thawing installation in a top view;

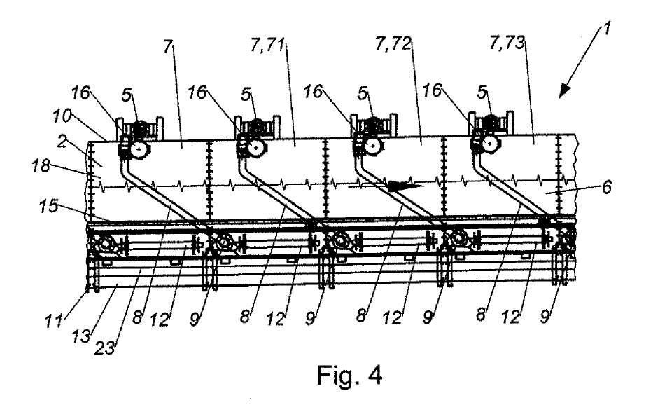

FIG. 3 shows a preferred embodiment of the wood-thawing installation as a section in a front view; and

FIG. 4 shows a detail from FIG. 1.

FIGS. 1 to 4 show a preferred embodiment of a wood-thawing installation 1 for thawing frozen raw wood pieces, wherein the wood-thawing installation 1 has a thawing channel 2, wherein the thawing channel 2 has an entrance 3 and an exit 4 for raw wood pieces, wherein nozzles 5 are arranged on the thawing channel 2 for introducing a thawing liquid 6 into the thawing channel 2.

A wood-thawing installation 1 is an installation for thawing wood, in particular raw wood, wherein the wood-thawing installation 1 is provided to receive the raw wood pieces in a frozen state and unfreeze them, i.e., raise the temperature thereof above the freezing point. The raw wood pieces can in particular be round wood pieces, preferably tree trunks.

The wood-thawing installation 1 has a thawing channel 2, through which the raw wood pieces can be conveyed. The thawing channel 2 can be formed in particular as an oblong basin.

For this purpose, the thawing channel 2 has an entrance 3 and an exit 4 for the raw wood pieces, wherein the raw wood pieces are conveyed from the entrance 3 to the exit 4. The conveyance direction of the raw wood pieces therefore extends from the entrance 3 to the exit 4. The conveyance direction is indicaₜed in FIGS. 1 and 4 by arrows.

The conveyance of the raw wood pieces in the thawing channel 2 can be performed in particular by means of a conveyor device 15, which preferably extends through the entire thawing channel 2, i.e., from the entrance 3 to the exit 4. The conveyor device 15 can in particular be a continuous conveyor, particularly preferably a chain conveyor.

The thawing channel 2 can particularly preferably be formed linear, as shown by way of example in FIGS. 1 and 2. In FIGS. 1 and 2, not all sections 7, 71, 72, 73 and not all features which are assignable to the individual sections 7, 71, 72, 73 and are repeating are provided with a reference sign.

Alternatively, it can be provided that the thawing channel 2 has at least one bend.

The thawing channel 2 is provided to receive a thawing liquid 6. The thawing liquid 6 can be water in particular. However, other thawing liquids 6 such as oils or mixtures of diverse liquids are also possible. In operation, the thawing liquid 6 emits its heat to the raw wood pieces, in order to thaw them. The level of the thawing liquid 6 in the thawing channel 2 is indicated in FIGS. 1 and 4 by a jagged line.

The quantity of the thawing liquid 6 in the thawing channel 2 can particularly preferably be selected such that the individual raw wood pieces do not float thereon.

The introduction of the thawing liquid 6 into the thawing channel 2 is performed via nozzles 5. The nozzles 5 identify an exit opening from the pump line 8 in this case.

It is provided that between the entrance 3 and the exit 4, a first section 7, 71 of the thawing channel 2 and a second section 7, 72 of the thawing channel 2 are arranged, the exit 4 is closer to the second section 7, 72 than the first section 7, 71, and at least one of the nozzles 5 is arranged in the first section 7, 71 and is connected via a pump line 8 to at least one suction opening 9 arranged in the second section 7, 72. In other words, between the entrance 3 and the exit 4, a first section 7, 71 of the thawing channel 2 and a second section 7, 72 of the thawing channel 2, which is arranged downstream of the first section 7, 71 viewed in the conveyance direction, are arranged, wherein at least one nozzle 5 of the first section 7, 71 is connected via a pump line 8 to at least one suction opening 9 of the second section 7, 72. The thawing liquid 6 is removed from the thawing channel 2 in this case by the suction opening 9 arranged in the second section 7, 72, pumped in the pump line 8 opposite to the conveyance direction, and introduced back into the thawing channel 2 in the first section 7, 71.

Furthermore, a method is provided for thawing frozen raw wood pieces, in particular in a wood-thawing installation 1, wherein the raw wood pieces are conveyed in a thawing channel 2, which is at least partially filled using a thawing liquid 6, firstly through a first section 7, 71 of the thawing channel 2 and subsequently through a second section 7, 72 of the thawing channel 2, wherein the thawing liquid 6 is pumped from the second section 7, 72 via a pump line 8 into the first section 7, 71.

The advantage thus results that the thawing method of the raw wood can be performed particularly energy efficiently, wherein in particular a core of the raw wood can also be thawed particularly reliably. Due to the construction of the thawing channel 2 in sections 7, 71, 72, 73, wherein a pump line 8 between the sections 7, 71, 72, 73 conveys the thawing liquid 6 opposite to a conveyance direction of the raw wood pieces, similarly as in a countercurrent heat exchanger, particularly good heat transfer from the thawing liquid 6 to the raw wood pieces can be achieved, wherein a local temperature difference between the thawing liquid 6 and the raw wood piece can be kept small. Furthermore, the raw wood piece can thus be in contact with an essentially hardly cooled and therefore particularly hot thawing liquid 6 at the exit 4 of the thawing channel 2, whereby the core of the raw wood piece can also be thawed particularly reliably. At the entrance 3 of the thawing channel 2, the thawing liquid 6 is already strongly cooled, wherein hardly any heat energy is lost by removing the thawing liquid 6 at this point.

Continuous recirculation of the thawing liquid 6 in the individual sections 7, 71, 72, 73 is also performed by the pump line 8, whereby the heat transfer between the raw wood pieces and the thawing liquid 6 is substantially increased in comparison to wresting thawing liquid 6.

Because the heat transfer essentially takes place between the thawing liquid 6 located in the thawing channel 2 and the raw wood pieces, a low pressure at the nozzles 5 is sufficient, whereby the nozzles 5 and the pump lines 8 can be designed simply. This is advantageous in particular because the thawing liquid 6 is generally strongly soiled, and therefore the application of a high pressure at the nozzles 5 would be very complex, and would require complex filtering of the thawing liquid 6 before the nozzle 5, for example.

A further advantage is that the raw wood pieces have buoyancy due to the thawing liquid 6 located in the thawing channel 2, whereby the load acting on the conveyor device 15 is substantially reduced. The conveyor device 15 can thus be designed substantially more simply.

The raw wood pieces can in particular be conveyed continuously through the various sections 7, 71, 72, 73.

The sections 7, 71, 72, 73 together form a continuous channel for the raw wood pieces, wherein adjacent sections 7, 71, 72, 73 are separated from one another by an imaginary plane located transversely in relation to the conveyance direction.

It can preferably be provided that the second section 7, 72 is arranged directly adjacent to the first section 7, 71. The second section 7, 72 therefore directly follows the first section 7, 71, whereby a particularly uniform temperature curve is achieved.

Alternatively, the pump line 8 can extend over more than one section 7, 71, 72, 73.

In particular, it can be provided that a third section 7, 73 of the thawing channel 2 is arranged between the second section 7, 72 of the thawing channel 2 and the exit 4, and at least one of the nozzles 5 is arranged in the second section 7, 72 and is connected via a pump line 8 to at least one suction opening 9 arranged in the third section 7, 72. In this case, the third section 7, 73 of the thawing channel 2 can preferably be arranged—viewed in the conveyance direction—after the second section 7, 72 of the thawing channel 2, wherein at least one nozzle 5 of the second section 7, 72 is connected via a pump line 8 to at least one suction opening 9 of the third section 7, 73. The second section 7, 72 is therefore a section 7, 71, 72, 73, the nozzle 5 of which is connected to the suction opening 9 of a downstream section 7, 71, 72, 73—viewed in the conveyance direction—while suction opening 9 of the second section 7, 72 is connected to the nozzle 5 of an upstream section 7, 71, 72, 73—viewed in the conveyance direction. The thawing liquid 6 is thus conveyed opposite to the conveyance direction of the raw wood pieces. In the case of many sections 7, 71, 72, 73, the individual sections can therefore be considered both as first section 7, 71, second section 7, 72, or third section 7, 73. This is clearly illustrated in FIG. 4, where the reference sign for the first section 7, 71, the second section 7, 72, and the third section 7, 73 is given once, wherein it is clear that this assignment can also be shifted in or opposite to the conveyance direction.

It can particularly preferably be provided that the thawing channel 2 has a plurality of substantially identically designed sections 7, 71, 72, 73, at least one nozzle 5, one suction opening 9, and one pump line 8 is arranged in each of these sections 7, 71, 72, 73, and the at least one nozzle 5 of each section 7, 71, 72, 73 is connected via the pump line 8 to a suction opening 9 arranged in another section 7, 71, 72, 73, which is closer to the exit 4. In this case, the at least one nozzle 5 of each section 7, 71, 72, 73 can be connected via its pump line 8 to a suction opening 9 of a—viewed in the conveyance direction—downstream section 7, 71, 72, 73.

The thawing channel 2 can therefore preferably comprise an array of substantially identically designed sections 7, 71, 72, 73, through which the raw wood pieces are conveyed. Via the pump lines 8, the thawing liquid 6 is pumped from section 7, 71, 72, 73 to section 7, 71, 72, 73 opposite to the conveyance direction, wherein the thawing liquid 6 emits its quantity of heat to the raw wood pieces in each section and thus cools down, while the raw wood pieces are continuously heated.

At the edges of the series of substantially identically designed sections 7, 71, 72, 73, edge sections 74 can be arranged, which are incomplete in comparison to the sections 7, 71, 72, 73 in the series, because they are no longer connected to an upstream or downstream section 7, 71, 72, 73.

In particular, it can be provided that one of the pump lines 8 only connects the at least one suction opening 9 of a single section 7, 71, 72, 73 to only the at least one nozzle 5 of another section 7, 71, 72, 73. In other words, one of the pump lines 8 only connects two sections 7, 71, 72, 73 to one another.

The thawing channel 2 can in particular have more than 5, preferably more than 10, particularly preferably more than 20 sections 7, 71, 72, 73.

The sections 7, 71, 72, 73 can particularly preferably be designed as segments which can be assembled. The wood-thawing installation 1 can thus be particularly simple to construct, and the length of the thawing channel 2 can be easily adapted.

The individual sections 7, 71, 72, 73 can in particular have a length between 1 m and 5 m, particularly preferably between 1.5 m and 2.5 m.

The pump line 8 can in particular have a pump 16, which pumps the thawing liquid 6 through the pump line 8. The pump 16 can in particular be a waste water pump. The pump 16 can in particular comprise an integrated grinding device, which grinds any wood parts in the thawing liquid 6 to be pumped.

The pump line 8 can in particular extend outside the thawing channel 2.

It can preferably be provided that the nozzles 5 are arranged on an upper side 10 of the thawing channel 2. The nozzles 5 can in particular—viewed in the operating position—be oriented downward. Raw wood pieces protruding out of the thawing liquid 6 thus have the thawing liquid 6 reliably poured over them from above in each section 7, 71, 72, 73, whereby particularly uniform heat transfer can occur.

The nozzles 5 can preferably be designed as fountain nozzles.

Each section 7, 71, 72, 73 can particularly have a plurality of nozzles 5.

The nozzles 5 can particularly preferably be oriented substantially transversely in relation to the conveyance direction of the raw wood pieces. Thus, the nozzles 5 do not cause a strong flow of the thawing liquid 6 in parallel to the conveyance direction, which would promote an exchange of the thawing liquid 6 between the individual sections 7, 71, 72, 73 within the thawing channel 2.

In particular, it can be provided that, in the individual sections 7, 71, 72, 73, the thawing liquid 6 flows in the flowing channel 2 substantially transversely in relation to the conveyance direction of the raw wood pieces, and a transport of the thawing liquid 6 between the sections 7, 71, 72, 73 is predominantly performed by the pump lines 8. The fact that a transport of the thawing liquid 6 between the sections 7, 71, 72, 73 is predominantly performed by the pump lines 8 means that at least half of the exchange of the thawing liquid 6 between two adjacent sections 7, 71, 72, 73 is performed via the pump line 8, and not as a flow in the thawing channel 2. The exchange of the thawing liquid 6 between two sections 7, 71, 72, 73 can thus be well monitored and specified, and is only dependent to a small extent on the filling quantity of the raw wood pieces in the thawing channel 2.

Furthermore, it can be provided that the suction openings 9 are arranged on a lower side 11 of the thawing channel 2. The thawing liquid 6, after it has completely traversed the individual section 7, 71, 72, 73, can thus be pumped away.

In particular, it can be provided that a compensation basin 14 is arranged below the thawing channel 2. The compensation basin 14 is used in particular as buffer storage for the thawing liquid 6, so that variations in the liquid level in the thawing channel 2 due to varying filling quantities of the raw wood pieces can be compensated for. Furthermore, the thawing channel 2 can thus be rapidly emptied in case of maintenance.

It can particularly preferably be provided that the thawing liquid 6 is heated in a heating device to a specified temperature and subsequently introduced into the thawing channel 2 in the region of the exit 4 of the thawing channel 2. The heating device can be in particular a burner or a heat exchanger, by which the heat energy required for the thawing process can be supplied to the thawing liquid 6. The heated thawing liquid 6 is thus only fed into the region of the exit 4 and can subsequently be pumped by the pump lines 8 via the individual sections 7, 71, 72, 73 opposite to the conveyance direction.

The heating device can in particular have a feed line, which opens into the thawing channel 2 in the region of the exit 4 of the thawing channel 2. The feed line can in particular open into an edge section 74 close to the exit 4.

Furthermore, it can be provided that the heating device removes the thawing liquid 6 from the thawing channel 2 at least indirectly from the region of the entrance 3 of the thawing channel 2. A closed loop can thus be achieved for the thawing liquid 6, wherein the thawing liquid 6 is cooled in the thawing channel from the exit 4 up to the entrance 3, and is subsequently heated again via the heating device.

This removal of thawing liquid 6 from the thawing channel 2 can be performed via a removal line from the region of the entrance 3 of the thawing channel 2.

Furthermore, it can be provided that the thawing liquid 6 exits from the thawing channel 2 into the compensation basin 14 in the region of the entrance 3. The thawing liquid 6 can subsequently be introduced from the compensation basin 14 into the heating device.

It can preferably be provided that the thawing liquid 6 is filtered in a filtering device before the heating device.

In particular, it can be provided that the thawing liquid 6 is heated in the heating device to a specified temperature of 50° C. to 99° C., in particular 60° C. to 70° C.

It can be provided that the thawing liquid 6 is introduced into the region of the exit 4 at a temperature of 50° C. to 99° C., in particular 60° C. to 70° C.

Furthermore, it can be provided that the thawing liquid 6 has, in the region of the entrance 3 of the thawing channel 2, a temperature of 0° C. to 15° C., in particular 0° C. to 7° C. When the thawing liquid 6 is brought out of the thawing channel 2 at such a low temperature, hardly any heat energy is lost unused.

It can particularly preferably be provided that a conveyor device 15 for a transverse transport of the raw wood pieces in the conveyance direction is arranged in the thawing channel 2. It can be provided in this case that the raw wood pieces are conveyed in transverse transport through the thawing channel 2. A high filling density of the raw wood pieces in the thawing channel 2 can thus be achieved. Furthermore, a flow of the thawing liquid 6 in parallel to the conveyance direction is thus suppressed by the raw wood pieces located transversely in relation to the conveyance direction in the thawing channel 2. It is thus possible to assist a transport of the thawing liquid 6 between the sections 7, 71, 72, 73 predominantly being performed via the pump lines 8.

Furthermore, it can be provided that the raw wood pieces are conveyed through the thawing channel 2 in multiple layers one on top of another, i.e., in particular as a woodpile.

It can particularly preferably be provided that the nozzles 5, in particular in each of the sections 7, 71, 72, 73, extend over an entire width of the thawing channel 2. This is shown in FIG. 2.

The thawing channel 2 can in particular be formed as an oblong basin. The thawing channel. 2 can have two side walls 18 in this case, which laterally delimit the space in the thawing channel 2. Furthermore, the thawing channel 2 can be closed on its end faces 19.

To introduce the raw wood pieces into the thawing channel 2, it can be provided that a delivery device 20 for the raw wood pieces is arranged at the entrance 3. The delivery device 20 can in particular have a slide 21 and a restraint device 22. The formation of a woodpile from the raw wood pieces can be assisted by the restraint device 22.

At the exit 4 of the thawing channel 2, it can be provided that the conveyor device 15 is formed rising in a ramp, to bring the raw wood pieces out of the thawing channel 2.

The frozen raw wood pieces can often have contaminants on the surface thereof, which are frozen on and fall off of the raw wood pieces during thawing and accumulate on the lower side 11 of the thawing channel 2.

In particular, it can be provided that a scraping device 12 and a lower channel 13, which extends in the longitudinal direction of the thawing channel 2, are arranged on the lower side 11 of the thawing channel 2, and the scraping device 12 is designed to bring contaminants on the lower side 11 of the thawing channel 2 into the lower channel 13. The scraping device 12 can in particular have a plurality of conveyors, in particular chain conveyors, which convey transversely in relation to the conveyance direction of the raw wood pieces. Contaminants can thus reliably be brought from the lower side 11 of the thawing channel 2 into the lower channel 13.

In this case, the lower channel 13 can be a further channel in the thawing channel 2 which extends in the longitudinal direction.

An upper edge of the scraping device 12 can be arranged lower in this case than an upper edge of the conveyor device 15. The scraping device 12 thus reliably removes the contaminants, without damaging the raw wood pieces.

It can particularly preferably be provided that a contaminant conveyor device 23 for the contaminants is arranged in the lower channel 13. The contaminant conveyor device 23 can be designed in particular as a continuous conveyor, in particular as a chain conveyor.

It can particularly preferably be provided that a conveyance direction of the contaminant conveyor device 23 extends from the exit 4 to the entrance 3. The contaminants can thus be expelled from the thawing channel 2 at the entrance 3 of the thawing channel 2, where the temperature of the thawing liquid 6 is lowest.

1.-14. (canceled)

15. A wood-thawing installation for thawing frozen raw wood pieces, comprising:
a thawing channel having an entrance and an exit for the raw wood pieces to enter and exit the thawing channel, said thawing channel including a first section and a second section which are located between the entrance and the exit, said exit being closer to the second section than the first section; and
a plurality of nozzles located on the thawing channel for introducing a thawing liquid into the thawing channel, at least one of the nozzles being located in the first section and connected via a pump line to a suction opening in the second section.

16. The wood-thawing installation of claim 15, wherein the second section is located directly adjacent to the first section.

17. The wood-thawing installation of claim 15, wherein the thawing channel has a third section located between the second section of the thawing channel and the exit, at least one of the nozzles being located in the second section and connected via a pump line to a suction opening in the third section.

18. The wood-thawing installation of claim 17, wherein the first, second and third sections of the thawing channel are of essentially identical configuration and arranged such that the nozzle of each of the first, second and third sections is connected via the corresponding one of the pipelines to the suction opening in the corresponding one of the first, second and third sections closer to the exit.

19. The wood-thawing installation of claim 15, wherein the nozzles are located on an upper side of the thawing channel.

20. The wood-thawing installation of claim 18, wherein the suction openings are located on a lower side of the thawing channel.

21. The wood-thawing installation of claim 20, further comprising a scraping device and a lower channel, said lower channel extending in a longitudinal direction of the thawing channel and being located on the lower side of the thawing channel, said scraping device being configured to direct contaminants on the lower side of the thawing channel into the lower channel.

22. The wood-thawing installation of claim 15, further comprising a compensation basin located below the thawing channel.

23. The wood-thawing installation of claim 15, further comprising a conveyor device located in the thawing channel for a transverse transport of the raw wood pieces in a conveyance direction.

24. A method for thawing frozen raw wood pieces, comprising:
at least partially filling a thawing channel with a thawing liquid; and
conveying the raw wood pieces in the thawing channel first through a first section of the thawing channel and then through a second section of the thawing channel by pumping the thawing liquid from the second section via a pump line into the first section.

25. The method of claim 24, configured for thawing frozen raw wood pieces in a wood-thawing installation.

26. The method of claim 24, further comprising heating the thawing liquid in a heating device to a specified temperature, and introducing the thawing liquid into the thawing channel in an exit region of the thawing channel.

27. The method of claim 26, wherein the thawing liquid is heated in the heating device to a specified temperature of 50° C. to 99° C.

28. The method of claim 26, wherein the thawing liquid is heated in the heating device to a specified temperature of 60° C. to 70° C.

29. The method of claim 24, wherein the thawing liquid flows in individual sections in the thawing channel substantially transversely relative to a conveyance direction of the raw wood pieces, and further comprising transporting the thawing liquid between the individual sections predominantly via pump lines.

30. The method of claim 24, wherein the raw wood pieces are conveyed in transverse transport through the thawing channel.
